(19) United States
(12) Patent Application Publication
(10) Pub. No.: US 2002/0193494 A1
(43) Pub. Date: Dec. 19, 2002

(54) Process for preparing an exfoliated, high I.V. polymer nanocomposite with an oligomer resin precursor and an article produced therefrom

(76) Inventors: John Walker Gilmer, Kingsport, TN (US); James Christopher Matayabas JR., Kingsport, TN (US); Gary Wayne Connell, Church Hill, TN (US); Jeffrey Todd Owens, Kingsport, TN (US); Sam Richard Turner, Kingsport, TN (US); Rodney Layne Piner, Kingsport, TN (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/198,916

(22) Filed: Jul. 19, 2002

Related U.S. Application Data
(63) Continuation of application No. 09/354,205, filed on Jul. 15, 1999.
(60) Provisional application No. 60/111,202, filed on Dec. 7, 1998.

(51) Int. Cl. C08K 3/34

(52) U.S. Cl. 524/445

(57) ABSTRACT

This invention is directed to a process for preparing an exfoliated, high I.V. polymer-platelet particle nanocomposite comprising the steps of: A process for preparing an exfoliated, high I.V. polymer-platelet particle nanocomposite comprising the steps of: (i) melt mixing platelet particles with an oligomeric polyamide resin to form an oligomeric resin-platelet particle composite, and (ii) mixing the oligomeric resin-platelet particle composite with a high molecular weight matrix polyamide having diamine and diacid repeat units, thereby increasing the molecular weight of the oligomeric resin-platelet particle composite and producing an exfoliated, high I.V. polymer nanocomposite material. The invention also is directed to a nanocomposite material produced by the process, products produced from the nanocomposite material, and a nanocomposite prepared from an oligomeric resin-platelet particle precursor composite.

### RELATED APPLICATION

This application is a continuation of, and claims the benefit of, application Ser. No. 09/354,205 filed Jul. 15, 1999, now pending, which claims priority to Serial No. 60/111,202, filed Dec. 7, 1998, both of which applications are hereby incorporated herein in their entirety by reference.

### BACKGROUND OF THE INVENTION

1. Field of the Invention

This invention relates generally to a nanocomposite prepared from an oligomeric resin-platelet particle precursor composite, a process for preparing a high inherent viscosity (I.V.) polymer nanocomposite material comprising at least one polymer resin and platelet particles uniformly dispersed therein, the nanocomposite material produced by the process, and products produced from the nanocomposite material.

2. General Background and Description of Related Art

Thermoplastic materials are being increasingly used in the packaging of beverages and perishable foods. Plastics are often the material of choice for food and beverage packaging because of their clarity, flexibility, toughness, high gas barrier, light weight, processability and high gloss.

Multilayer materials for packaging are also known for film, bottles, and other containers. Multilayer injection molded preforms described, for example, in European Patent Application 0 278 403 A2, contain an outer thermoplastic layer to impart excellent overall properties to the material and an inner layer of thermoplastic resin possessing excellent gas-barrier properties. Molded containers produced from these multilayer preforms have potential advantages in regards to handling, safety, and the cost of production. However, processing multilayer containers usually involves additional and time consuming steps.

Polyamides and poly(ethylene-co-vinyl alcohol) provide high barrier to prevent the diffusion of many gases such as oxygen and carbon dioxide. In general, however, high barrier materials also command a higher price, thus prohibiting their extensive use for oxygen sensitive foods and beverages. For example, although the oxygen barrier of the polyamide poly(m-xylyladipamide) (MXD6) is approximately 20 times greater than that of poly(ethylene terephthalate) (PET), MXD6 and PEN materials are not nearly so widely used as PET, even with oxygen sensitive applications such as beer containers, which demand higher barrier.

Polyester Materials

Useful polyesters have high inherent viscosities (I.V.) which allow the polyester to be formed into a parison and subsequently molded into a container. However, because of the limited barrier properties with regard to oxygen, carbon dioxide and the like, PET containers are not generally used for products requiring long shelf life or that have high sensitivity to spoilage by oxygen. For example, oxygen transmission into PET bottles that contain beer, wine and certain food products cause these products to spoil.

The preparation of polymer-platelet particle composites containing, for example, nylon-6 and alkyl ammonium treated montmorillonite have been disclosed. Most prior attempts to improve gas barrier properties used polyamides due to their hydrogen bonding character and corresponding synergistic interaction with the negatively charged clay. However, the application of this technology to polyesters, particularly to improve gas barrier properties, has been limited due to the inability to achieve the required level of dispersion of the clay particles.

Processes to prepare polymer composites by incorporating platelet particles during polymer synthesis are limited to low I.V.'s and to low loadings of platelet particles due to the increasing low shear melt viscosity with the increased loading of delaminated platelet particles. For example, JP Kokai patent no. 9-176461 discloses the preparation of polyester composites containing unmodified sodium montmorillonite and bottles prepared from these polyester composites. Example 11 of U.S. Pat. No. 4,889,885 describes the polycondensation of dimethyl terephthalate and ethylene glycol in the presence of 33 weight percent of a montmorillonite clay in water (for 6.2 final weight percent of clay in the polyester resin). However, the foregoing references produce materials comprising very large tactoids and little, if any dispersion of individual platelet particles. Nor do the references disclose polymer-platelet compositions having other specific properties such as oxygen permeability.

Extruders are well suited for mixing materials with high low-shear melt viscosity that shear thin at high shear rates. Extrusion compounding approaches have been shown to give intercalation of high molecular weight, melt processable polymers between the platelets of layered clay materials; however, the preparation of polyester-platelet composites comprising mostly delaminated, individual platelet particles has not been demonstrated by a compounding process.

WO 93/04117 and WO 93/04118 disclose extrusion blending of up to 60 weight percent of intercalated clay materials with a wide range of polymers including polyamides, polyesters, polyurethanes, polycarbonates, polyolefins, vinyl polymers, thermosetting resins and the like. Although the use of polyesters are disclosed as useful polymers and an example of a PET/organoclay nanocomposite is provided in WO 93/04118, compositions prepared as described exhibit insufficient clay dispersion and do not lead to improved barrier due to lack of separation.

U.S. Pat. Nos. 5,552,469 and 5,578,672 describe the preparation of intercalates derived from certain clays and water-soluble polymers such as polylvinyl pyrrolidone, polyvinyl alcohol, and polyacrylic acid. The specification describes a wide range of thermoplastic resins including polyesters and rubbers that can be used in blends with these intercalates. The compositions prepared as described exhibit insufficient clay dispersion and do not lead to improved barrier due to lack of separation. The inability to contribute to gas barrier would not be predicted based on the disappearance of the d(001) montmorillonite X-ray diffraction pattern as observed in FIG. 5 of U.S. Pat. No. 5,578,672.

Polyamide Materials

Regarding polyamide materials, the principle of utilizing a platelet filler, e.g., a layered clay, to enhance properties is well established. U.S. Pat. No. 4,739,007 describes the use of a composite material comprised of a polyamide matrix and well-dispersed silicate layers exhibiting high mechanical strength and excellent high temperature properties. Additional publications describing polymer nanocomposites comprising a polyamide matrix and dispersed layers of silicate include U.S. Pat. No. 4,810,734; German Patent 3808623; J. Inclusion Phenomena 5, (1987), 473-485; Clay Minerals, 23, (1988) 27; Polymer Preprints, 32, (April 1991), 65-66; and Polymer Preprints, 28, (August 1987), 447-448.

Therefore, previous patents and applications have claimed to produce by extrusion compounding polymeric (polyester and polyamide) composites comprised of intercalated or exfoliated platelet particles, as indicated either by large basal spacing values or the lack of a detectable basal spacing value by X-ray. However, the polymer/platelet particle composites of the prior art are believed to be dispersions of aggregates with large thickness, typically greater than about 20 nm. While the aggregates were well spaced, very few individual platelets and tactoids or particles with thickness less than about 10 nm could be found. Without achieving a good dispersion and small particle size, improved gas barrier properties are difficult to achieve.

Thus, there remains a need in the art for a process capable of introducing high loadings of substantially separated platelet particles to polymers, including polyesters and polyamides, to produce a nanocomposite having a high I.V., improved barrier properties and good thermal stability.

### SUMMARY OF THE INVENTION

As embodied and broadly described herein, this invention, in one embodiment, relates to an exfoliated, high I.V. polymer-platelet particle nanocomposite comprising a high molecular weight matrix polymer, and platelet particles exfoliated in the matrix polymer, wherein the platelet particles are dispersed in a matrix polymer-compatible oligomeric resin and wherein the platelet particle-oligomer resin dispersion is incorporated into the matrix polymer.

In another embodiment, this invention relates to a process for preparing an exfoliated, high I.V. polymer-platelet particle nanocomposite comprising the steps of: (i) melt mixing platelet particles with a matrix polymer-compatible oligomeric resin to form an oligomeric resin-platelet particle composite, and (ii) mixing the oligomeric resin-platelet particle composite with a high molecular weight matrix polymer thereby increasing the molecular weight of the oligomeric resin-platelet particle composite and producing an exfoliated, high I.V. polymer nanocomposite material.

In another embodiment, this invention relates to a process for preparing an exfoliated, high I.V. polymer-platelet particle nanocomposite comprising melt mixing platelet particles, a matrix polymer-compatible oligomeric resin, and a high molecular weight matrix polymer, thereby increasing the molecular weight of the mixture and producing an exfoliated, high I.V. polymer nanocomposite material.

In another embodiment, this invention relates to a process for preparing an exfoliated, high I.V. polymer-platelet particle nanocomposite comprising the steps of: (i) melt mixing platelet particles with an oligomeric resin to form an oligomeric resin-platelet particle composite, and (ii) increasing the molecular weight of the oligomeric resin-platelet particle composite by reactive chain extension of the oligomeric resin to produce an exfoliated, high I.V. nanocomposite material.

In yet another embodiment, this invention relates to a process for preparing an exfoliated, high I.V. polymer-platelet particle nanocomposite comprising the steps of: (i) contacting a clay with an organic cation to form an organoclay comprising platelet particles, (ii) melt mixing the organoclay with a matrix polymer-compatible oligomeric resin to form an oligomeric resin-platelet particle composite, and (iii) introducing the oligomeric resin-platelet particle composite into a high molecular weight matrix polymer, thereby increasing the molecular weight of the oligomeric resin-platelet particle composite and producing an exfoliated, high I.V. polymer nanocomposite material.

Additional advantages of the invention will be set forth in part in the detailed description, including the figures, which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory of preferred embodiments of the invention, and are not restrictive of the invention, as claimed.

### BRIEF DESCRIPTION OF THE FIGURES

FIG. l is a wide angle X-ray diffraction pattern taken using a Cu K X-ray source for the nanocomposite material of Example 17.

FIG. 2 is a wide angle X-ray diffraction pattern taken using a Cu K X-ray source for the nanocomposite material of Example 18.

FIG. 3 is a wide angle X-ray diffraction pattern taken using a Cu K X-ray source for the nanocomposite material of Example 19.

FIG. 4 is a wide angle X-ray diffraction pattern taken using a Cu K X-ray source for the nanocomposite material of Comparative Example 2.

FIG. 5 is a wide angle X-ray diffraction pattern taken using a Cu K X-ray source for the nanocomposite material of Comparative Example 3.

FIG. 6 is a wide angle X-ray diffraction pattern taken using a Cu K X-ray source for the nanocomposite material of Comparative Example 4.

### DETAILED DESCRIPTION OF THE INVENTION

The present invention may be understood more readily by reference to the following detailed description of the invention, including the appended figures referred to herein, and the examples provided therein. It is to be understood that this invention is not limited to the specific processes and conditions described, as specific processes and/or process conditions for processing plastic articles as such may, of course, vary. It is also to be understood that the terminology used herein is for the purpose of describing particular embodiments only and is not intended to be limiting.

Definitions

It must also be noted that, as used in the specification and the appended claims, the singular forms “a,” “an” and “the” include plural referents unless the 20 context clearly dictates otherwise. For example, reference to processing or forming an “article,” “container” or “bottle” from the process or nanocomposite of this invention is intended to include the processing of a plurality of articles, containers or bottles.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Whenever used in this specification, the terms set forth shall have the following meanings:

“Layered clay material,” “Layered clay,” or “Layered material” shall mean any organic or inorganic material or mixtures thereof, such as a smectite clay mineral, which is in the form of a plurality of adjacent, bound layers. The layered clay comprises platelet particles and is typically swellable.

“Platelets,” “platelet particles” or “particles” shall mean individual or aggregate unbound layers of the layered material. These layers may be in the form of individual platelet particles, ordered or disordered small aggregates of platelet particles (tactoids), and small aggregates of tactoids.

“Dispersion” or “dispersed” is a general term that refers to a variety of levels or degrees of separation of the platelet particles. The higher levels of dispersion include, but are not limited to, “intercalated” and “exfoliated.” “Intercalated” or “intercalate” shall mean a layered clay material that includes oligomer and/or polymer molecules disposed between adjacent platelet particles or tactoids of the layered material to increase the interlayer spacing between the adjacent platelets and tactoids.

“Exfoliate” or “exfoliated” shall mean platelets dispersed mostly in an individual state throughout a carrier material, such as a matrix polymer. Typically, “exfoliated” is used to denote the highest degree of separation of platelet particles.

“Exfoliation” shall mean a process for forming an exfoliate from an intercalated or otherwise less dispersed state of separation.

“Nanocomposite” shall mean a polymer or copolymer having dispersed therein a plurality of individual platelets obtained from an exfoliated, layered material.

“Matrix polymer” shall mean a thermoplastic or thermosetting polymer in which the platelet particles are exfoliated to form a nanocomposite.

### DESCRIPTION OF THE EMBODIMENTS

This invention relates generally to a process for preparing a high I.V. polymer nanocomposite material comprising at least one polymer resin and platelet particles uniformly dispersed therein, the nanocomposite material produced by the process, products produced from the nanocomposite material, and a nanocomposite prepared from an oligomeric resin-platelet particle precursor composite. The nanocomposite material exhibits improved gas barrier properties when formed into an article.

More particularly, this invention relates to a process comprising the steps of (1) preparing an oligomeric resin-platelet particle composite by melt-mixing platelet particles and an oligomeric resin and (2) preparing a high I.V. polymer-platelet nanocomposite material.

The molecular weight of the polymer material may be increased by any of a number of known approaches or by any combination of these approaches, e.g., chain extension, reactive extrusion, extrusion let-down, solid state polymerization or annealing, annealing under a flow of inert gas, vacuum annealing, let-down in a melt reactor, etc. Polymer nanocomposites produced according to the present invention display a gas permeability which is at least 15 percent lower than that of the unmodified polymer.

The prior art has defined the degree of separation of the platelet particles based on peak intensity and basal spacing value, or lack of predominant basal spacing, as determined by X-ray analyses of polymer-platelet composites. Even though X-ray analysis alone often does not unambiguously predict whether or not the platelet particles are individually dispersed in the polymer, it can often allow quantification of the level of dispersion achieved. As such, X-ray analysis only provides information related to the well ordered aggregates, which are only a small portion of the platelet particles present. Moreover, in polymer nanocomposites, X-ray analysis alone does not accurately predict the dispersion of the platelet particles in neither the polyester nor the resultant gas barrier improvement. TEM images of polymer-platelet composites show that platelet particles which are incorporated into at least one polymer exist in a variety of forms, including, but not limited to individual platelets (the exfoliated state), disordered agglomerates of platelets, well ordered or stacked aggregates of platelets (tactoids), swollen aggregates of stacked platelets (intercalated tactoids), and aggregates of tactoids.

Without being bound by any particular theory, it is believed that the degree of improved gas barrier (permeability) depends upon the embodiment ratio of the resulting particle platelets and aggregates, the degree to which they are dispersed or uniformly distributed, and the degree to which they are ordered perpendicular to the flux of the permeant.

To obtain the improvements in gas permeability and the enhanced melt viscosity according to the present invention, it is preferable that the platelet particles representative of the bulk of the composite be exfoliated, and preferably be highly exfoliated, in the matrix polymer such that the majority, preferably at least about 75 percent and perhaps as much as at least about 90 percent or more of the platelet particles, be dispersed in the form of individual platelets and aggregates having a thickness in the shortest dimension of less than about 20 nm and preferably less than about 10 nm, as estimated from TEM images. Polymer-platelet nanocomposites containing more individual platelets and fewer aggregates, ordered or disordered, are most preferred. Significant levels of incomplete dispersion (i.e., the presence of large agglomerates and tactoids greater than about 20 nm) not only lead to an exponential reduction in the potential barrier improvements attributable to the platelet particles, but also can lead to deleterious affects to other properties inherent to polyamide resins such as strength, toughness, and heat resistance.

Again, without being bound by a particular theory, it is believed that delamination of platelet particles upon melt mixing with a polymer requires favorable free energy of mixing, which has contributions from the enthalpy of mixing and the entropy of mixing. Melt mixing platelet particles with polymers results in a negative entropy of mixing due to the reduced number of conformations which a polymer chain has when it resides in the region between two layers of clay. It is believed that poor dispersion is obtained using melt processible polyesters because the enthalpy of mixing is not sufficient to overcome the negative entropy of mixing. In contrast, generally good dispersions are obtained with polyamides due to their hydrogen bonding character. However, the extent of this dispersion is frequently lessened because of the negative entropy of mixing. Efforts to achieve a favorable enthalpy of mixing of platelet particles with melt processible polymers by pretreating the platelet particles (e.g., by cation exchange with alkyl ammonium ions) have been unsuccessful.

Regarding the present invention, it has also been found that the use of low molecular weight polymers (oligomeric polymers) for melt mixing with platelet particles gives good dispersion, creating mostly individual particles. Without being bound by any particular theory, it is believed that the entropy of mixing decreases with decreasing number average molecular weight of the polymer, thereby decreasing the free energy of mixing, which improves dispersion and increases the probability of delaminating the platelet particles into individual platelets.

Desirable values for the I.V. or molecular weight of the oligomer depends on factors including the oligomer and clay selected as is readily determined by those skilled in the art.

Therefore, the process of this invention is operative for all polymers for which a method of increasing the composite molecular weight (or I.V) is desired. The process of this invention, although particularly useful with polyamides, is especially useful for polymers that lack the hydrogen bonding characteristic of polyamides, such as polyesters.

Process, Nanocomposites and Articles Produced Therefrom

As stated, this invention relates generally to a process comprising the steps of (1) preparing an oligomeric resin-platelet particle composite by melt mixing platelet particles and an oligomeric resin and (2) preparing a high molecular weight polymer-platelet nanocomposite material.

In a first embodiment, this invention relates to a process for preparing an exfoliated, high I.V. polymer-platelet particle nanocomposite comprising the steps of: (i) melt mixing platelet particles with a matrix polymer-compatible oligomeric resin to form an oligomeric resin-platelet particle composite, and (ii) mixing the oligomeric resin-platelet particle composite with a high molecular weight matrix polymer thereby increasing the molecular weight of the oligomeric resin-platelet particle composite and producing an exfoliated, high I.V. polymer nanocomposite material.

Although any melt mixing device may be used, typically, the melt mixing step is conducted either by a batch mixing process or by a melt compounding extrusion process during which treated or untreated layered particles are introduced into an oligomeric resin. Prior to melt mixing, the treated or untreated layered particles may exist in various forms including pellets, flakes, chips and powder. It is preferred that the treated or untreated layered particles be reduced in size by methods known in the art, such as hammer milling and jet milling. Prior to melt mixing, the oligomeric resin may exist in wide variety of forms including pellets, ground chips, powder and its molten state.

Referring to the first embodiment of this invention, in one embodiment, the melt mixing step may be achieved by dry mixing oligomeric resin with treated or untreated layered particles then passing the mixture through a compounding extruder under conditions sufficient to melt the oligomeric resin.

In another embodiment of the first embodiment, the melt-mixing step is conducted by feeding the oligomeric resin and treated or untreated layered particles separately into a compounding extruder. When treated layered particles are used in this process, it is preferred that the oligomeric resin be added first to minimize degradation of treated layered particles.

Use of extrusion compounding to mix the clay and the polymer presents two advantages. Chiefly, the extruder is able to handle the high viscosity exhibited by the nanocomposite material. In addition, in a melt mixing approach for producing nanocomposite materials, the use of solvents can be avoided. Low molecular weight liquids can often be costly to remove from the nanocomposite resin.

In a second embodiment of this invention, a high concentration of layered particles is melt mixed with oligomeric resin by mixing in a reactor. The resulting composite material is then either chain extended, polymerized to high molecular weight, or let down in the extruder into a high molecular weight polymer to obtain the final nanocomposite material.

The oligomeric resin and the high molecular weight polymer may have the same or different repeat unit structure, i.e., may be comprised of the same or different monomer units. Preferably, the oligomeric resin has the same monomer unit to enhance compatibility or miscibility with the high molecular weight polymer.

In another embodiment of this invention, molten oligomeric resin may be fed directly to a compounding extruder along with treated or untreated layered particles to produce the oligomeric resin-platelet particle nanocomposite.

If desired, a dispersing aid may be present during or prior to the formation of the composite by melt mixing for the purposes of aiding exfoliation of the treated or untreated swellable layered particles into the polymer. Many such dispersing aids are known, covering a wide range of materials including water, alcohols, ketones, aldehydes, chlorinated solvents, hydrocarbon solvents, aromatic solvents, and the like or combinations thereof.

Formation of a high I.V. polymer-platelet particle nanocomposite may be achieved by several different methods. For polyesters, these include, but are not limited to solid state polymerization, melt compounding with melt processible polyester, and their combinations. In one embodiment of this invention, the I.V. of the oligomeric polyester-platelet particle composite is increased by solid state polymerization. In another embodiment of this invention, the oligomeric polyester-platelet particle composite is compounded with a melt processible polyester and used as is or is increased in I.V. by solid state polymerization. The monomer unit of the melt processible polyamide may be the same as or different than the oligomeric polyamide.

For polyamides, formation of a high I.V. nanocomposite includes, but is not limited to, reactive chain extension of an oligomeric polyamide-platelet particle composite, and melt compounding of an oligomeric polyamide composite with a high molecular weight, melt processible polyamide. The monomer unit of the melt processible polyamide may be the same as or different than the oligomeric polyamide.

This invention also relates to a polyester nanocomposite material comprising a polyester having dispersed therein platelet particles derived from various clay materials which may be untreated, metal intercalated, organically modified through cation ion exchange, or intercalated with other high molecular weight pretreatment compounds. The polyester nanocomposite is preferably a polyethylene terephthalate polymer or copolymer nanocomposite having an I.V. of at least 0.4 dL/g, preferably at least 0.5 dL/g.

This invention also relates to a polyamide nanocomposite material comprising a polyamide having dispersed therein platelet particles derived from various clay materials which may be untreated or metal intercalated, organically modified through cation exchange, or intercalated with other high molecular weight pretreatment compounds. Any polyamide may be used in the process of this invention. The polyamide nanocomposite is preferably a poly(m-xylylene adipamide) polymer or copolymer nanocomposite having an I.V. of at least 0.5 dL/g, preferably at least 0.7 dL/g.

This invention also relates to articles prepared from the nanocomposite material of this invention, including, but not limited to film, sheet, pipes, tubes, profiles, molded articles, preforms, stretch blow molded films and containers, injection blow molded containers, extrusion blow molded films and containers, thermo formed articles, and the like. The containers are preferably bottles.

The articles may also be multilayered. Preferably, the multilayered articles have a nanocomposite material disposed intermediate to other layers, although the nanocomposite may also be one layer of a two-layered article. In a more preferred embodiment, the article has five layers comprising (a) a first and fifth layer comprising poly(ethylene terephthalate) or a copolymer thereof, (b) a third layer comprising recycled poly(ethylene terephthalate) or a copolymer thereof, and (c) a second and fourth layer formed from the nanocomposite.

All of these additives and many others and their use are known in the art and do not require extensive discussion. Therefore, only a limited number will be referred to, it being understood that any of these compounds can be used in any combination of the layers so long as they do not hinder the present invention from accomplishing its objects.

In embodiments where the nanocomposite and its components are approved for food contact, the nanocomposite may form the food contact layer of the desired articles. In other embodiments, it is preferred that the nanocomposite be in a layer other than the food contact layer.

In another embodiment of this invention, the polymer-platelet particle nanocomposite and the molded article or extruded sheet may be formed at the same time by co-injection molding or co-extruding.

Another embodiment of this invention is the combined use of silicate layers uniformly dispersed in the matrix of a high barrier thermoplastic together with the multilayer approach to packaging materials. By using a layered clay to decrease the gas permeability in the high barrier layer, the amount of this material that is needed to generate a specific barrier level in the end application is greatly reduced. Since the high barrier material is often the most expensive component in multilayer packaging, a reduction in the amount of this material needed can be quite beneficial. With the nanocomposite layer being sandwiched between two outer polymer layers, the surface roughness is often considerably less than for a monolayer nanocomposite material. Thus, with a multilayer approach, the level of haze is reduced.

Polyesters

The I.V. of the oligomeric polyester prior to melt mixing is preferably from about 0.05 and 0.5 dL/g, and more preferably from 0.1 dL/g to 0.3 dL/g as measured in a mixture of 60 weight percent phenol and 40 weight percent 1,1,2,2-tetrachloroethane at a concentration of 0.5 g/100 ml (solvent) at 25° C. Preferably, the I.V. of the high molecular weight matrix polymer is at least 0.6 dL/, and more preferably is 0.7 dL/g as measured in a mixture of 60 weight percent phenol and 40 weight percent 1,1,2,2-tetrachloroethane at a concentration of 0.5 g/100mi (solvent) at 25° C. Moreover, the oligomeric polyester has a number average molecular weight of from about 200 to about 10,000 g/mol and may be a homo or cooligomer.

Suitable polyesters include at least one dibasic acid and at least one glycol. The primary dibasic acids are terephthalic, isophthalic, naphthalenedicarboxylic, 1,4-cyclohexanedicarboxylic acid and the like. The various isomers of naphthalenedicarboxylic acid or mixtures of isomers may be used, but the 1,4-, 1,5, 2,6-, and 2,7-isomers are preferred. The 1,4-cyclohexanedicarboxylic acid may be in the form of cis, trans, or cis/trans mixtures. In addition to the acid forms, the lower alkyl esters or acid chlorides may be also be used.

The preferred polyester is poly(ethylene terephthalate) (PET) or a copolymer thereof. The copolymer may be prepared from two or more of the following dicarboxylic acids or glycols.

The dicarboxylic acid component of the polyester may optionally be modified with up to about 50 mole percent of one or more different dicarboxylic acids. Such additional dicarboxylic acids include dicarboxylic acids having from 6 to about 40 carbon atoms, and more preferably dicarboxylic acids selected from aromatic dicarboxylic acids preferably having 8 to 14 carbon atoms, aliphatic dicarboxylic acids preferably having 4 to 12 carbon atoms, or cycloaliphatic dicarboxylic acids preferably having 8 to 12 carbon atoms. Examples of suitable dicarboxylic acids include terephthalic acid, phthalic acid, isophthalic acid, naphthalene-2,6-dicarboxylic acid, cyclohexanedicarboxylic acid, cyclohexanediacetic acid, diphenyl-4,4′-dicarboxylic acid, phenylenedi(oxyacetic acid) succinic acid, glutaric acid, adipic acid, azelaic acid, sebacic acid, and the like. Polyesters may be prepared from two or more of the above dicarboxylic acids.

Typical glycols used in the polyester include those containing from two to about ten carbon atoms. Preferred glycols include ethylene glycol, propanediol, 1,4-butanediol, 1,6-hexanediol, 1,4-cyclohexanedimethanol, diethylene glycol and the like. The glycol component may optionally be modified with up to about 50 mole percent, preferably up to about 25 mole percent, and more preferably up to about 15 mole percent of one or more different diols. Such additional diols include cycloaliphatic diols preferably having 6 to 20 carbon atoms or aliphatic diols preferably having 3 to 20 carbon atoms. Examples of such diols include: diethylene glycol, triethylene glycol, neopentyl glycol, 1,4-cyclohexanedimethanol, propane-1,3-diol, butane-1,4-diol, pentane-1,5-diol, hexane-1,6-diol, 3-methylpentanediol-(2,4), 2-methylpentanediol-(1,4), 2,2,4-trimethylpentane-diol-(1,3), 2-ethylhexanediol-(1,3), 2,2-diethylpropane-diol-(1,3), hexanediol-(1,3), 1,4-di-(2-hydroxyethoxy)-benzene, 2,2b-is-(4-hydroxycyclohexyl)-propane, 2,4-dihydroxy-1,1,3,3-tetramethyl-cyclobutane, 2,2-bis-(3-hydroxyethoxyphenyl)-propane, 2,2-bis-(4-hydroxypropoxyphenyl)-propane and the like. Polyesters may be prepared from two or more of the above diols.

Small amounts of multifunctional polyols such as trimethylolpropane, pentaerythritol, glycerol and the like may be used, if desired. When using 1,4-cyclohexanedimethanol, it may be the cis, trans or cis/trans mixtures when using phenylenedi(oxyacetic acid) it may be used as 1,2; 1,3; 1,4 isomers or mixtures thereof.

The resin may also contain small amounts of trifunctional or tetrafunctional comonomers to provide controlled branching in the polymers. Such comonomers include trimellitic anhydride, trimethylolpropane, pyromellitic dianhydride, pentaerythritol, trimellitic acid, trimellitic acid, pyromellitic acid and other polyester forming polyacids or polyols generally known in the art.

Polyamides

The I.V. of the oligomeric polyamide prior to melt mixing is preferably from about 0.1 and 0.5 dL/g, and more preferably from 0.3 dL/g to 0.5 dL/g as measured in a mixture of 60 weight percent phenol and 40 weight percent 1,1,2,2-tetrachloroethane at a concentration of 0.5 g/100 ml (solvent) at 25° C. Preferably, the I.V. of the high molecular weight matrix polymer is at least 0.7 dL/g and more preferably is at least 1.0 dL/ g as measured in a mixture of 60 weight percent phenol and 40 weight percent 1,1,2,2-tetrachloroethane at a concentration of 0.5 g/100 ml (solvent) at 25° C. Moreover, the oligomeric polyamide has a number average molecular weight of from about 200 to about 10,000 g/mol and may be a homo or cooligomer.

Suitable polyamides used in the process of this invention include those prepared by ring opening polymerization of lactams and those prepared by condensation polymerization of diacids and diamines. Examples of suitable polyamides include poly(m-xylylene adipamide) or a copolymer thereof, isophthalic acid-modified poly(m-xylylene adipamide), nylon-6, nylon-6,6, and the like, or mixtures thereof.

Although not required, additives normally used in polymers may be used, if desired. Such additives include colorants, pigments, carbon black, glass fibers, impact modifiers, antioxidants, surface lubricants, denesting agents, UV light absorbing agents, metal deactivators, fillers, nucleating agents, stabilizers, flame retardants, reheat aids, crystallization aids, acetaldehyde reducing compounds, recycling release aids, oxygen scavenging materials, or mixtures thereof, and the like.

All of these additives and many others and their use are known in the art and do not require extensive discussion. Therefore, only a limited number will be referred to, it being understood that any of these compounds can be used in any combination of the layers so long as they do not hinder the present invention from accomplishing its objects.

Platelet Particles

The compositions of the present invention comprise up to about 25 weight percent, preferably from 0.1 and 15 weight percent, more preferably from 0.5 to 15 weight percent and most preferably from 0.5 and 10 weight percent of certain platelet particles derived from organic and/or inorganic clay materials. The amount of platelet particles is determined by measuring the amount of ash of the polyester-platelet compositions when treated in accordance with ASTM D5630-94, which is incorporated herein by reference.

The platelet particles of the present invention have a thickness of less than about 2 nm and a diameter in the range of about 10 to about 5000 nm. For the purposes of this invention measurements refer only to the platelet particle and not any dispersing aids or pretreatment compounds which might be used.

Suitable platelet particles are derived from clay materials which are free flowing powders having a cation exchange capacity between about 0.3 and about 3 meq/g and preferably between about 0.8 and about 1.5 meq/g. Examples of suitable clay materials include mica-type layered natural, synthetic or modified phyllosilicates, including clays, smectite clays, sodium montmorillonite, sodium hectorite, bentonite, nontronite, beidelite, volonsloite, saponite, sauconite, magadite, kenyaite, synthetic sodium hectorite, and the like. Clays of this nature are available from various companies including Southern Clay Products and Nanocor, Inc. Generally, the clay materials are a dense agglomeration of platelet particles, which are closely stacked together like cards.

The most preferred clay material used for the nanocomposite and process of this invention is Wyoming-type montmorillonite or Wyoming-type bentonite.

Other non-clay materials having the above-described ion-exchange capacity and size, such as chalcogens, may also be used as the source of platelet particles under the present invention. Chalcogens are salts of a heavy metal and group VIA (O, S, Se, and Te). These materials are known in the art and do not need to be described in detail here.

Improvements in gas barrier also result from increases in the concentration of platelet particles in the polymer. While amounts of platelet particles as low as 0.01 percent provide improved barrier (especially when well dispersed and ordered), compositions having at least about 0.5 weight percent of the platelet particles are preferred because they display the desired improvements in gas permeability.

Generally, it is desirable to treat the selected clay material to facilitate separation of the agglomerates of platelet particles to individual platelet particles and small tactoids. Separating the platelet particles prior to incorporation into the polymer also improves the polymer/platelet interface. Any treatment that achieves the above goals may be used. Examples of useful treatments include intercalation with water-soluble or water insoluble polymers, organic reagents or monomers, silane compounds, metals or organometallics, organic cations to effect cation exchange, and their combinations.

Treatment of the clay can be accomplished prior to the addition of a water dispersible polymer to the clay material, during the dispersion of the clay with the water soluble polymer or during a subsequent melt blending or melt fabrication step.

Examples of useful pretreatment with polymers and oligomers include those disclosed in U.S. Pat. Nos. 5,552,469 and 5,578,672, incorporated herein by reference. Examples of useful polymers for intercalating the platelet particles include polyvinyl pyrrolidone, polyvinyl alcohol, polyethylene glycol, polytetrahydrofuran, polystyrene, polycaprolactone, certain water dispersible polyesters, Nylon-6 and the like.

Examples of useful pretreatment with organic reagents and monomers include those disclosed in EP 780,340 A1, incorporated herein by reference. Examples of useful organic reagents and monomers for intercalating the platelet particles include dodecylpyrrolidone, caprolactone, caprolactam, ethylene carbonate, ethylene glycol, bishydroxyethyl terephthalate, dimethyl terephthalate, and the like or mixtures thereof.

Examples of useful pretreatment with silane compounds include those treatments disclosed in WO 93/11190, incorporated herein by reference. Examples of useful silane compounds includes (3-glycidoxypropyl)trimethoxysilane, 2-methoxy (polyethyleneoxy)propyl heptamethyl trisiloxane, octadecyl dimethyl (3-trimethoxysilylpropyl) ammonium chloride and the like.

Organic Cations

Numerous methods to modify layered particles with organic cations to form an organoclay are known, and any of these may be used in the process of this invention. One embodiment for preparing an organoclay is the modification of a swellable layered particle with an onium cation. Typically, an organoclay is prepared by dispersing a layered particle material in hot water, most preferably from 50 to 80° C., adding an organic cation salt (onium cation) or combinations of organic cation salts (neat or dissolved in water or alcohol) with agitation, then blending for a period of time sufficient for the organic cations to exchange most of the metal cations present in the galleries between the layers of the clay material. Then, the organically modified layered particulate material is isolated by methods known in the art including, but not limited to, filtration, centrifugation, spray drying, and their combinations.

It is desirable to use a sufficient amount of the organic cation salt to permit exchange of most of the metal cations in the galleries of the layered particle for organic cations; therefore, at least about 1 equivalent of organic cation salt is used and up to about 3 equivalents of organic cation salt can be used. It is preferred that about 0.5 to 2 equivalents of organic cation salt be used, more preferable about 1 .1 to 1.5 equivalents. It is often desirable, but not required, to remove most of the metal cation salt and most of the excess organic cation salt by washing and by other techniques known in the art.

Useful organic cation salts for the process of this invention can be represented as follows:

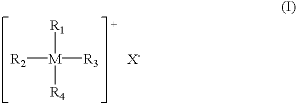

wherein M is nitrogen or phosphorous; X⁻ is a halide, hydroxide, or acetate anion, preferably chloride and bromide; R₁, R₂, R₃ and R₄ are independently organic and oligomeric ligands or hydrogen. Examples of useful organic ligands include, but are not limited to, linear or branched alkyl groups having 1 to 22 carbon atoms, aralkyl groups which are benzyl and substituted benzyl moieties including fused ring moieties having linear chains or branches of 1 to 22 carbon atoms in the alkyl portion of the structure, aryl groups such as phenyl and substituted phenyl including fused ring aromatic substituents, beta, gamma unsaturated groups having six or less carbon atoms, and alkyleneoxide groups having 2 to 6 carbon atoms. Examples of useful oligomeric ligands include, but are not limited to, poly(alkylene oxide), polystyrene, polyacrylate, polycaprolactone, and the like.

In one embodiment, the organic cation is not an organic cation salt represented by Formula (I):

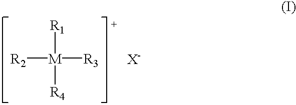

wherein M is nitrogen or phosphorous, X⁻ is a halide, hydroxide, or acetate anion, R₁ is a straight or branched alkyl group having at least 8 carbon atoms, and R₂, R₃, and R₄ are independently hydrogen or a straight or branched alkyl group having 1 to 4 carbon atoms.

Examples of useful organic cations include, but are not limited to, alkyl ammonium ions, such as dodecyl ammonium, octadecyl ammonium, bis(2-hydroxyethyl) octadecyl methyl ammonium, octadecyl benzyl dimethyl ammonium, tetramethyl ammonium, and the like or mixtures thereof, and alkyl phosphonium ions such as tetrabutyl phosphonium, trioctyl octadecyl phosphonium, tetraoctyl phosphonium, octadecyl triphenyl phosphonium, and the like or mixtures thereof.

Illustrative examples of suitable polyalkoxylated ammonium compounds include those available under the trade name ETHOQUAD or ETHOMEEN from Akzo Chemie America, namely, ETHOQUAD 18/25 which is octadecyl methyl bis(polyoxyethylene[15]) ammonium chloride and ETHOMEEN 18/25 which is octadecyl bis(polyoxyethylene[15])amine, wherein the numbers in brackets refer to the total number of ethylene oxide units. The most preferred organic cation is octadecyl methyl bis(polyoxyethylene[15]) ammonium chloride.

The particle size of the organoclay is reduced in size by methods known in the art, including, but not limited to, grinding, pulverizing, hammer milling, jet milling, and their combinations. It is preferred that the average particle size be reduced to less than 100 microns in diameter, more preferably less than 50 microns in diameter, and most preferably less than 20 microns in diameter.

It should be appreciated that on a total composition basis, dispersing aids and/or pretreatment compounds may account for significant amount of the total composition, in some cases up to about 30 weight percent. While it is preferred to use as little dispersing aid/pretreatment compounds as possible, the amounts of dispersing aids and/or pretreatment compounds may be as much as about 8 times the amount of the platelet particles.

### EXAMPLES

The following examples and experimental results are included to provide those of ordinary skill in the art with a complete disclosure and description of particular manners in which the present invention can be practiced and evaluated, and are intended to be purely exemplary of the invention and are not intended to limit the scope of what the inventors regard as their invention. Efforts have been made to ensure accuracy with respect to numbers (e.g., amounts, temperature, etc.); however, some errors and deviations may have occurred. Unless indicated otherwise, parts are parts by weight, temperature is in ° C. or is at ambient temperature, and pressure is at or near atmospheric.

Polyester Examples

The following examples illustrate 1) the preparation of an organoclay, 2) the preparation of an oligorneric polyester-platelet particles composite by melt mixing the organoclay with a PET oligomer that was prepared by esterification of terephthalic acid and ethylene glycol, 3) extrusion compounding the oligomeric polyester-platelet particle composite with PET, and 4) the solid state polymerization of the polyester-platelet composite to high I.V.

### Example 1

Example 1 illustrates the preparation of an organoclay.

36.0 g (34.2 meq) of sodium montmorillonite (supplied by Southern Clay Products and reported to have a cation exchange capacity of 95 milliequivalents/100 grams) and 1800 ml of distilled water at 100° C. were blended in a Waring Commercial Heavy Duty Blender for 2.5 minutes at the highest stirring rate (about 1000 rpm). 33.5 g (34.2 meq) of octadecyl-methyl-[ethoxylated(15)] ammonium chloride (commercially available as ETHOQUAD 18/25) in 200 ml of hot distilled water were added to the mixer and blended for 2.5 minutes. The solids were then removed by filtration with a 3000 mL Buchner funnel with medium fritted disk. The wet solids were then slurried in 500 mL of water in a Waring Commercial Heavy Duty Blender and filtered. The filtercake was dried at 80° C. in a vacuum oven (with nitrogen sweep) for 16 hours to provide 28 grams of a light tan solid. Analysis by X-ray diffraction showed a basal spacing of 3.38 nm. Ash residue, which is a measure of the inorganic content, was 52.1 weight percent. The material was passed through a hammer mill then a jet mill to reduce the number average particle size to about 7 microns.

### Example 2

A mixture of 31.4 weight percent of the organoclay from Example 1 and 68.6 weight percent of oligo(ethylene terephthalate) (OET) (number average molecular weight of 382 g/mole, I.V. of about 0.08 dL/g, 8.7 weight percent residual ethylene glycol, catalyst content 243 ppm antimony) is dried overnight in a vacuum oven at 100° C. Analysis by X-ray diffraction of this physical mixture showed the characteristic basal spacing of the clay at about 3.4 nm with an X-ray intensity of about 72,000. The mixture is then compounded on a Leistritz Micro 18 corotating twin screw extruder at 220° C. with a die temperature of 230° C. A general compounding screw is utilized at a rate of 200 RPM. After melt blending, analysis by X-ray diffraction showed a reduction of intensity to about 18,000 indicating that the basal spacing of the clay of 3.4 nm had an improved exfoliation of the clay in the resulting composite, with only about 25% of the original clay tactoids remaining (note: the percent (%) calculation is a simple % of the original X-ray intensity, 100%×18,000/72,000=25%). Transmission electron micrograph (TEM) imaging of this material shows the presence of mostly individual platelet particles and some tactoids and aggregates.

### Example 3

The procedure of Example 2 was repeated using oligo(ethylene terephthalates) with I.V.'s ranging from about 0.06 to about 0.46 dL/g. The results of X-ray diffusion intensity of the 3.4 nm basal spacing of the organoclay presented in Table 1 show that the amount of organoclay tactoids, as indicated by X-ray intensity, increases with increasing I.V. of the oligo(ethylene terephthalate). This experiment demonstrates the utility of using low I.V. oligo(ethylene terephthalate) to prepare polymer-platelet particle composites with improved exfoliation of the platelet particles. Table 1 is shown below.

TABLE 1

| | | X-ray | |
|---|---|---|---|
| Sample | I.V. (dL/g) | intensity | % Tactoids |
| 1 | 0.06 | 21,000 | 29 |
| 2 | 0.18 | 6,800 | 9 |
| 3 | 0.24 | 27,000 | 37 |
| 4 | 0.26 | 24,000 | 33 |
| 5 | 0.30 | 34,000 | 43 |
| 6 | 0.33 | 27,000 | 37 |
| 7 | 0.46 | 40,000 | 54 |

### Example 4

A mixture of 10.6 g of the organoclay of Example 1, 115 g of oligo(ethylene terephthalate) (I.V. of about 0.08 dL/g), and 2.7 g of cyclohexane dimethanol is melt mixed in a heavy-walled IL flask under a nitrogen atmosphere at 220° C., held at 220° C. for about 15 minutes, and heated to about 280° C. over a period of about 15 minutes. The material was removed from the flask and ground to pass a 4 mm screen. Analysis of the resulting composite indicated an I.V. of 0.12 dL/g, an ash value of 4.6 weight %, and an X-ray diffraction intensity of about 20,000 for the 3.4 nm basal spacing of clay.

The above oligomeric polyester-platelet particle composite is annealed in a solid stating unit heated with refluxing diethyl succinate (about 215° C.) with a nitrogen flow rate of 10 SCFH for 24 hours. The I.V. is increased to about 0.63 dL/g.

The above polyester-platelet particle composite is dried overnight in a vacuum oven at 120° C. with a slight nitrogen purge. The dried material is compression molded at 280° C. then quenched in ice water to provide clear films with thickness of about 10 mil. Oxygen permeability of the film was determined to be 4.2 cc-mil/100 in²-24 hr-atm, a value markedly improved from unmodified PET (10.4 cc-mil/100 in²-24 hr-atm). Thus, the polyester-platelet particle composite has significantly improved barrier properties.

### Comparative Example 1

A mixture of 360.9 grams of ground PET 9921 polymer and 39.1 grams of the organoclay from Example 1 is dried overnight in a vacuum oven at 105° C. The mixture is dry-blended and then compounded in the Leistritz Micro 18 extruder at 275° C. with a die temperature of 280° C. employing a general compounding screw at a rate of 250 rpm. The extrudate is pelletized and characterized and the sample is solid stated for 16 hours to an I.V. of 0.510 dL/g. At this I.V., a 10-mil film is compression molded and tested for oxygen permeability with the resulting barrier measurement of 10.1, a value not markedly different from unmodified PET 9921 (10.4).

The lack of improvement in oxygen barrier obtained for PET by the extrusion compounding with clay is indicative of the poor dispersion of the clay layers into PET matrix.

### Example 5

A mixture of 90 weight percent of PET-9921 and 10 weight percent of the oligomeric polyester-platelet particle composite from Example 2 was dried overnight in a vacuum oven at 100° C. then compounded on a Leistritz Micro 18 corotating twin screw extruder at 280° C. A general compounding screw was utilized at a rate of 200 RPM.

The above polyester-platelet composite material was dried overnight in a vacuum oven at 120° C. with a slight nitrogen purge. The dried material was placed into a glass solid state polymerization unit with a nitrogen purge of 14 scfh and heated by boiling diethyl succinate, which has a boiling point of 218° C. After a period of 8 hours, heating was discontinued and the solid state polymerization unit was allowed to cool. After cooling, the composite material was removed. Analytical results showed that the composite had an I.V. value of 0.6 dL/g, a low shear melt viscosity at 280° C. of 25×10³ poise, an ash residue of 2.0 weight percent, and a melting point of about 250° C., and the following glycol residues based on 100 mole percent total glycol residues: 2.8 mole percent diethylene glycol, 3.2 mole percent 1,4-cyclohexane dimethanol, and 94 mole percent ethylene glycol. TEM imaging of this polyester-platelet nanocomposite shows the presence of mostly individual platelets and few tactoids and aggregates.

The above polyester-platelet nanocomposite was dried overnight in a vacuum oven at 120° C. with a slight nitrogen purge. The dried material was compression molded at 280° C. then quenched in ice-water to provide clear films with thickness of about 10 mil. Testing conducted on the films gave an average oxygen permeability of 2.0 cc-mil/100in²-24 hr-atm; thus, the polyester-particle composite has significantly improved barrier properties.

### Example 6

200 g of the oligomeric polyester-platelet particle composite from Example 2 was annealed in an electrically heated solid stating unit with a nitrogen flow rate of 10 scfh. The temperature was initially held for 4 hours at 180° C., raised to 190° C. for 1 hour, raised to 200° C. for 1 hour, raised to 210° C. for 1.5 hours, and raised to 220° C. for 2 hours. Microscopic analysis of the nanocomposite material showed that a high level of clay dispersion is maintained during solid state annealing.

### Example 7

The procedure of Example 2 was followed except that the organoclay used was a bis(2-hydroxyethyl)-methyl-tallow ammonium chloride (ETHOQUAD T/12) treated sodium montmorillonite, as disclosed in WO 96/08526, obtained from Southern Clay Products. The amount of organoclay used was in the melt compounding step was 23.2 weight percent.

### Example 8

The procedure of Example 2 was followed except that the organoclay used was a bis(2-hydroxyethyl)-methyl-octadecyl ammonium chloride treated sodium montmorillonite obtained from Southern Clay Products. The amount of organoclay used was in the melt compounding step was 27 weight percent.

### Example 9

The procedure of Example 2 was followed except that the sodium montmorillonite used was Kanupia F available from Kunimine Ind., Inc. The amount of organoclay used was in the melt compounding step was 32.6 weight percent.

### Example 10

The procedure of Example 5 was followed except that the amount of organoclay used in the melt compounding step was 51.6 weight percent.

### Example 11

The procedure of Example 5 was repeated except that 25 weight percent of the oligomeric polyester-platelet particle composite of Example 2 was used.

### Example 12

The procedure of Example 5 was repeated except that 40 weight percent of the oligomeric polyester-platelet particle composite of Example 2 was used.

### Example 13

The procedure of Example 7 was repeated except that the extruder used was a APV 19 mm corotating twin screw extruder. The temperature of the initial zones of the barrel are set at 220° C. and the temperature of the last zone and the die are set at 240° C. The APV was configured to feed directly into the first zone of the Leistritz Micro 18 Extruder with a barrel and die temperature of 280° C. PET 9921 is fed into the feed hopper of the Leistritz Extruder to allow the clay/OET mixture to be let down into PET. For both extruders, a general compounding screw is utilized at a rate of 200 RPM.

### Example 14

The procedure of Example 6 was repeated except the material from Example 10 was used instead of the material from Example 2. Microscopic analysis of the nanocomposite material shows that a high level of clay dispersion is maintained during solid state annealing. The weight average molecular weight of the polyester matrix is determined by size exclusion chromatography to be about 40,000 g/mole.

### Example 15

The procedure of Example 6 was repeated except the material from Example 12 was used instead of the material from Example 2. Microscopic analysis of the nanocomposite material shows that a high level of clay dispersion is maintained during solid state annealing. The weight average molecular weight of the polyester matrix is determined by size exclusion chromatography to be about 40,000 g/mole.

### Example 16

The procedure of Example 6 was repeated except the material from Example 13 was used instead of the material from Example 2. Microscopic analysis of the nanocomposite material shows that a high level of clay dispersion is maintained during solid state annealing. The weight average molecular weight of the polyester matrix is determined by size exclusion chromatography to be about 40,000 g/mole.

Polyamide Examples

In the following examples, to obtain a highly exfoliated m-xylyladipamide polyamide (MXD6) nanocomposite, oligomeric MXD6 is mixed with a series of montmorillonite organoclays. These materials are melt mixed in a laboratory reactor and an assessment is conducted of their dispersion into the MXD6. The morphology of these composite materials is then evaluated to assess which organoclay exhibited the greatest tendency to exfoliate into the MXD6 oligomer.

### Example 17

A low molecular weight m-xylyladipamide polyamide (oligomeric MXD6) was prepared. This material was analyzed by titration of the amine and carboxylate end groups to possess a number average molecular weight of about 3,000, and was determined to have an I.V. of about 0.41 dL/g. 306.4 grams of this oligomeric poly(m-xylyladipoyl diamine) was dry mixed with 55 grams of SCPX-1578 organomontmorillonite clay purchased from Southern Clay Products and then dried at 110° C. overnight in a vacuum oven. The mixture was then extruded on the Leistritz Micro 18 corotating twin screw extruder equipped with a general compounding screw. The AccuRate pellet feeder was set at a rate of approximately 2 kg/hr with a nitrogen atmosphere over both the feeder and the hopper. The barrel and die temperatures were set at 280° C. and the screw RPM at approximately 275. After the extrusion was complete, 100 grams of the extrudate pellets are dry-mixed with 300 grams of MXD6 6001 polyamide pellets purchased from Mitsubishi Chemical. The MxD6 polyamide possessed an I.V. of about 1.1 dL/g. The mixture was then extruded on the Leistritz extruder under the same conditions used with the clay polymer mixture but at a feed rate of 2.0 to 2.5 kg/hour.

The material obtained was then characterized by optical microscopy (OM), transmission electron microscopy (TEM) and by wide angle X-ray diffraction (WAXD) to determine the degree of dispersion of the organoclay into the polymer matrix and to assess the morphology of the composite material. The WAXD analysis was carried out on a ground sample of the material using an X-ray diffractometer equipped with a Cu Kα X-ray source. The diffraction profile from the organoclay exhibits a diffraction maximum corresponding to a basal spacing value of 1.8 nm. For the nanocomposite material, no diffraction maximum is exhibited in the WAXD profile (FIG. 1). The X-ray intensity decreases monotonically throughout the entire angular range of the diffraction angle, θ from 1.5° to 10°. By optical microscopy it is determined that the composite material exhibits a high degree of clarity, indicating that most of the organoclay is well distributed into the matrix of the polymer. The transmission electron micrographs verified that, in most cases, each of the clay layers is exfoliated, i.e. individually dispersed in the polymer matrix.

A film was formed from the nanocomposite material by compression molding on a hydraulic press at 280° C. followed by immediate quenching in ice water to minimize crystallization on cooling. The oxygen barrier of the film was then determined on a Mocon 2/20 oxygen permeability tester to be 0.03 cc mil/100 in²-24 hr.-atm.

### Example 18

The procedure of Example 17 was repeated using 300 grams of the oligomeric poly(m-xylyladipoyl diamine) dry mixed with 50.6 grams of SCPX-1580 organomontmorillonite clay purchased from Southern Clay Products, and then 120 grams of the oligomeric nanocomposite extrudate pellets and 300 grams of MXD6 6001 polyamide pellets.

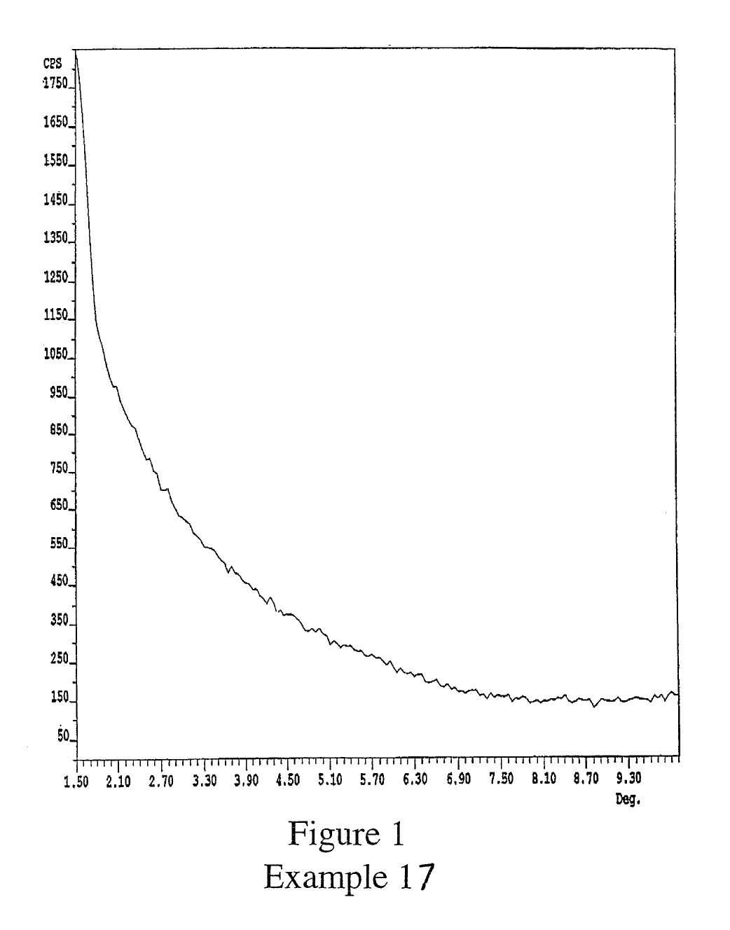

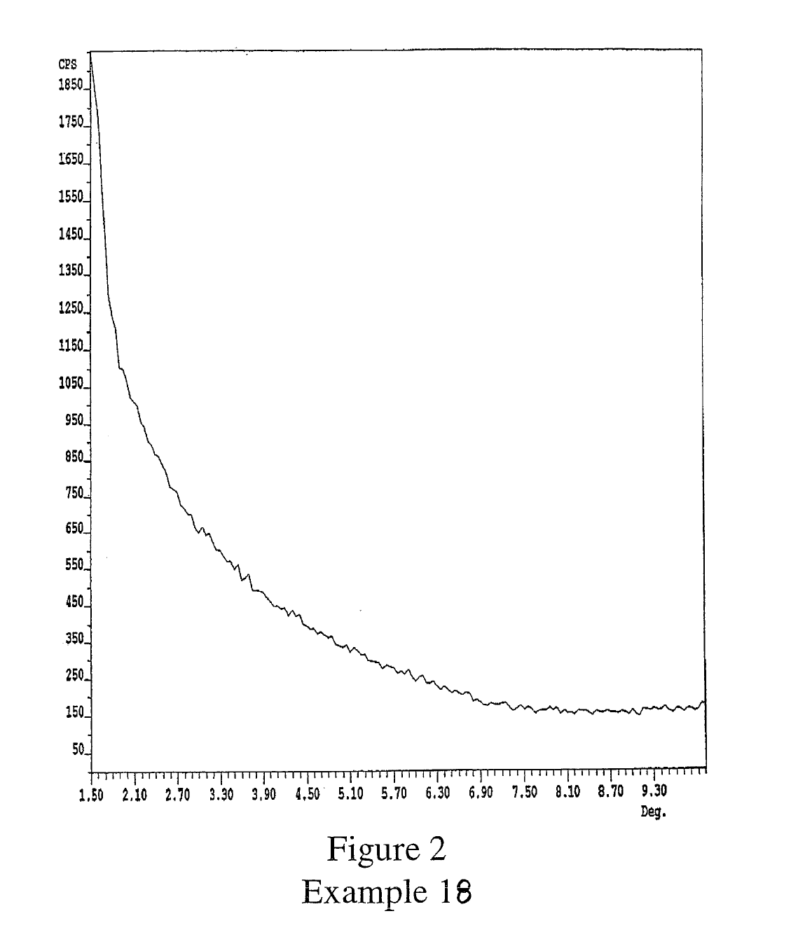

The morphology of the product was assessed in a manner similar to that described in Example 17. For the nanocomposite material, no diffraction maximum was exhibited in the WAXD profile (FIG. 2), with the X-ray intensity decreasing monotonically throughout the entire angular range. By optical microscopy a high degree of clay dispersion was observed for the composite material. The transmission electron micrographs verified that, in most cases, each of the clay layers is exfoliated.

A film was formed from the nanocomposite material by compression molding on a hydraulic press at 280° C. followed by immediate quenching in ice water to minimize crystallization on cooling. The oxygen barrier of the film was then determined on a Mocon 2/20 oxygen permeability tester to be 0.04 cc mil/100 in²-24 hr.-atm.

### Example 19

The procedure of Example 18 was repeated using 76 grams of SCPX-1961 montmorillonite clay purchased from Southern Clay Products in place of SCPX-1580.

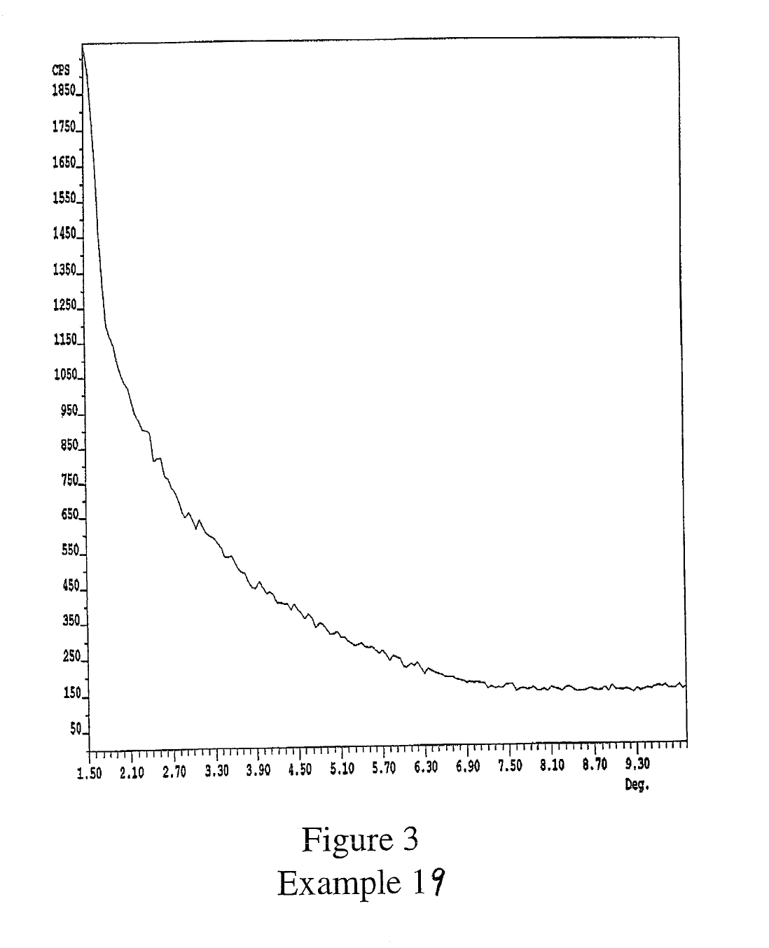

The morphology of this material was assessed in a manner similar to that described in Example 17. For the nanocomposite material, only very weak diffraction maxima were exhibited in the WAXD profile (FIG. 3), indicative of basal spacing values of approximately 2 and 3.7 nm. By optical microscopy a high degree of clay dispersion was observed for the composite material. The transmission electron micrographs verify that, in most cases, each of the clay layers is exfoliated.

### Example 20

In this example, 4854 grams of oligomeric poly(m-xylyladipoyl diamine) was dry mixed with 836 g of SCPX-1578, both described in Example 17. The mixture, prior to compounding, was dried overnight in a vacuum oven at 100° C. and then allowed to cool. This material was then processed on a Werner-Pfleiderer 30 mm twin screw extruder (WP-30) equipped with general compounding screws, with the RPM set at 300. The temperature profile of the extruder barrel was set with the first zone at 200° C. increasing eventually to 260° C. at the die zone. The extrude was collected, ground and vacuum dried overnight at 100° C. A dry blend was then made of 4666 g of this extrudate with 11913 g of MXD6 6007, purchased from Mitsubishi Chemical Company. The mixture was than extruded and pelletized on the WP-30 with a processing temperature of 260° C. and a screw RPM of 300. The resulting material was then dried overnight at approximately 110° C. in a vacuum oven.

The morphology of this material was assessed in a manner similar to that described in Example 17. The transmission electron micrographs verified that, in most cases, each of the clay layers is exfoliated. For the nanocomposite material, no diffraction maximum was exhibited in the WAXD profile. The X-ray intensity decreases monotonically throughout the entire angular range of the diffraction angle, θ from 1.5° to 10°. When this material was analyzed by ashing, 2.8% of the original weight was obtained.

The pellets of this material were forwarded to two plastics processing firms for the injection molding of tri-layer preforms and the subsequent stretch blow molding into bottles. The oxygen permeability of the bottle sidewall was determined on the Mocon Ox-tran 2/20 oxygen permeability tester. The oxygen permeability of the barrier layer of the bottle sidewall was characterized at 0.04 cc/100 in²-24 hr-atm and 0.06 cc/100 in²-24 hr-atm for the bottles prepared by the two multilayer injection molding presses with subsequent stretch blow molding.

Bottle controls were prepared containing MXD6 6007 as the barrier layer. The oxygen permeability of the sidewall barrier materials in these bottles was approximately 0.3 cc/100 in²-24 hr-atm.

### Example 21

In this example, 500 grams of oligomeric poly(m-xylyladipoyl diamine), described in Example 17, was dry mixed with 68.9 grams of SCPX-1580 montmorillonite clay, described Example 18. The mixture was dried overnight in a vacuum oven at 120° C., allowed to cool, and then mixed with 29.6 grams of pyromellitic dianhydride purchased from Aldrich Chemical Company. This material was then processed on a Leistritz Micro 18 corotating twin screw extruder equipped with general compounding screw. A feed rate of approximately 1.5 kg/hour was selected using an AccuRate feeder. The material was processed at 280° C. and 250 rpm with a vacuum hose attached to the vent port on the 7^{th} zone of the extruder.

The morphology of this material was assessed in a manner similar to that described in Example 17. The transmission electron micrographs verified that, in most cases, each of the clay layers is exfoliated. For the nanocomposite material, no diffraction maximum was exhibited in the WAXD profile. The X-ray intensity decreases monotonically throughout the entire angular range of the diffraction angle, θ from 1.5° to 10°. The low angle laser light scattering (LALLS) results of the nanocomposite indicate that the weight average molecular weight of the polyamide component increased from 6,000 g/mole to 18,000 g/mole as a result of the chain extension process.

### Example 22

In this example 200 grams of poly(m-xylyladipoyl diamine) polyamide, described in Example 17, was dry mixed with 8.3 grams of SCPX-1580 montmorillonite clay, described Example 18. The mixture was dried overnight in a vacuum oven at 120° C., allowed to cool, and added to a 500 ml round bottom flask. This material was purged with nitrogen gas, evacuated, and flushed again with nitrogen gas. The material was then melted and processed at 280° C. for 1 hour under constant stirring.

The morphology of this material was assessed in a manner similar to that described in Example 17. The transmission electron micrographs verified that, in most cases, the clay layers are exfoliated. For the nanocomposite material, no diffraction maximum was exhibited in the WAXD profile. The X-ray intensity decreases monotonically throughout the entire angular range of the diffraction angle, θ from 1.5° to 10°.

### Example 23

75.0 grams of an amine terminated oligomeric poly(m-xylyladipamide) with I.V. of 0.43 dL/g, 3.20 grams of adipic acid, 2.16 grams of SCPX-1580 onium ion intercalated clay, and 50.0 grams of water were charged to a 500-mL round-bottom flask fitted with a short distillation column and a mechanical stirrer. Under a dynamic nitrogen atmosphere the flask was heated at 100 C with stirring at 150 rpm for about 1.5 hrs. Then the temperature was increased to 275° C. over a period of about 1.5 hr to drive off the water and melt the reactants. The material kept at 275° C. for about 30 minutes. The resulting product had an I.V. of about 0.80 dL/g and analysis by WAXS showed no basal spacing of the clay.

This example demonstrates the formation of a nanocomposite using oligomeric polyamide and chain extension of the oligomeric polyamide to high polymer.

### Comparative Example 2

931 grams of MXD6 6001, poly(m-xylyladipoyl diamine) with an I.V. of about 1.1 dL/g, was dry mixed with 68.9 grams of SCPX-1578 montmorillonite clay, described in Example 17. The mixture was dried at 110° C. overnight in a vacuum oven then extruded on the Leistritz Micro 18 extruder. Equipped with a general compounding screw. The AccuRate pellet feeder was set at a rate of approximately 2 kg/hr with a nitrogen atmosphere over both the feeder and the hopper. The barrel and die temperatures were set at 280° C. and the screw RPM at approximately 275.

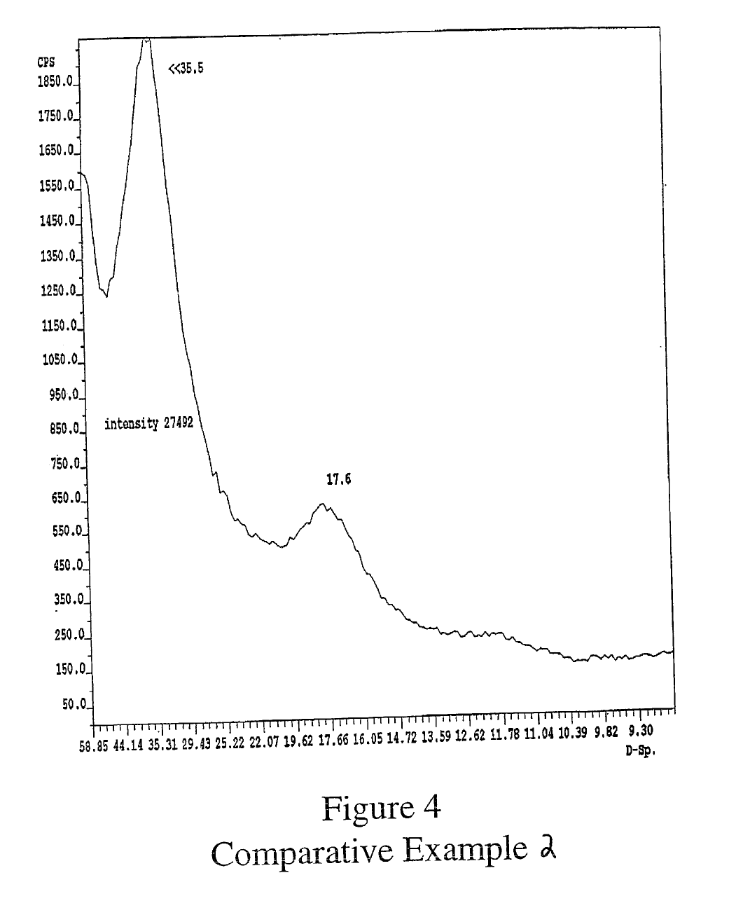

The morphology of this material was assessed in a manner similar to that described in Example 17. For the nanocomposite material, in the WAXD profile, (FIG. 4) diffraction maxima are observed indicative of a basal spacing values at about 1.76 and 3.55 nm.

By optical microscopy, a high fraction of larger clay particles is observed for the composite material. The transmission electron micrographs of the composite material exhibit many clay tactoids comprised of low numbers of clay layers.

### Comparative Example 3

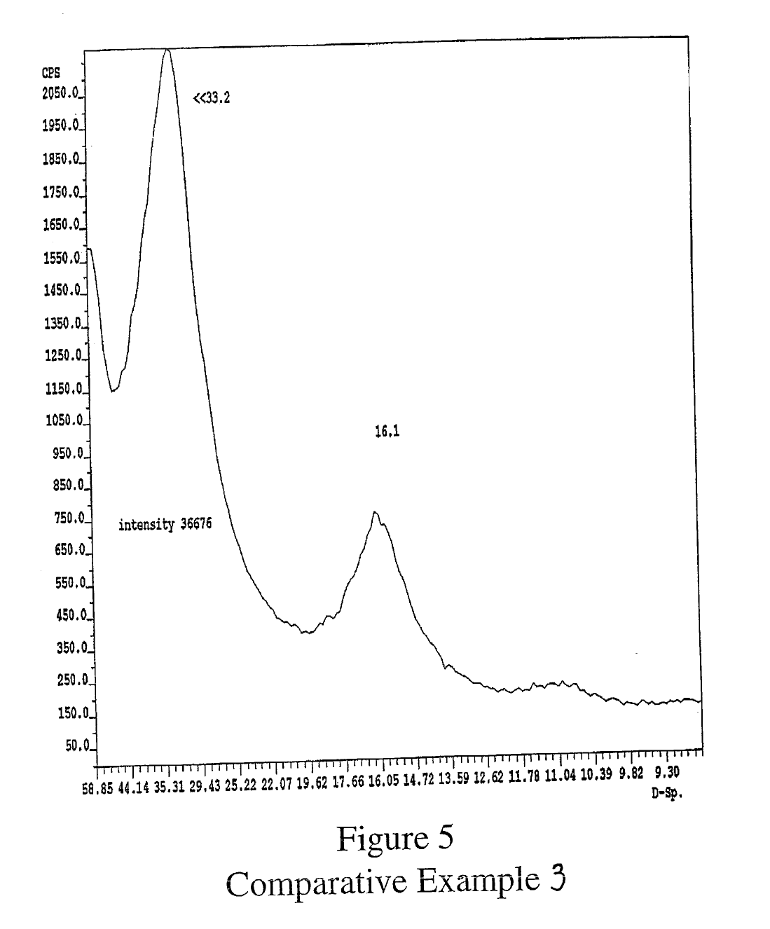

The procedure of Comparative Example 2 was repeated using 932 grams of MXD6 6001 poly(m-xylyladipoyl diamine) and 67.6 grams of SCPX-1580 montmorillonite clay, both described in Example 18. The morphology of this material was assessed in a manner similar to that described in Example 17. For the nanocomposite material, in the WAXD profile (FIG. 5), a diffraction maximum is observed indicative of a basal spacing values at about 1.61 and 3.32 nm.

By optical microscopy, a high fraction of larger clay particles is observed for the composite material. The transmission electron micrographs of the composite material exhibit many clay tactoids comprised of several layers.

### Comparative Example 4

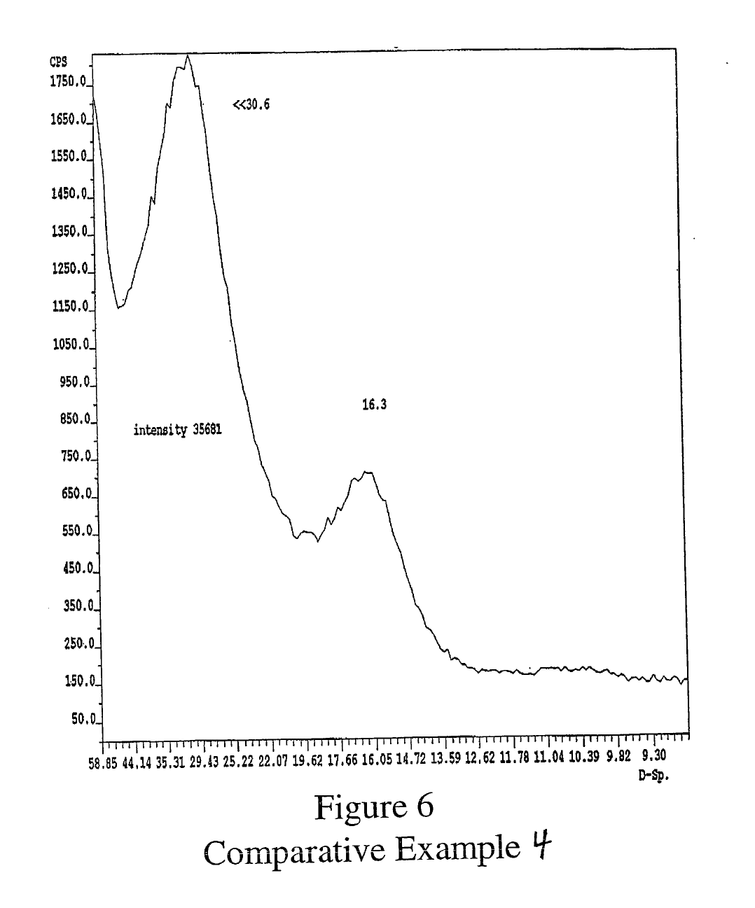

The procedure of Comparative Example 2 was repeated using 900 grams of MXD6 6001 poly(m-xylyladipoyl diamine) and 100 grams of SCPX-1961 montmorillonite clay, described in Example 17. The morphology of this material was assessed in a manner similar to that described in Example 17. For the nanocomposite material, in the WAXD profile (FIG. 6), a diffraction maximum is observed indicative of a basal spacing values at about 1.63 and 3.06 nm.

By optical microscopy, a high fraction of larger clay particles is observed for the composite material. The transmission electron micrographs of the composite material exhibit many clay tactoids comprised of several layers.

A comparison of the above Examples, which incorporate oligomer precursors (polyester and polyamide) thereby forming a composite prior to forming a high molecular weight nanocomposite material, with the Comparative Examples (that do not utilize an oligomer) illustrates that using an oligomer precursor improves the state of exfoliation of the resulting nanocomposite. By improving the exfoliated state, higher barrier articles may be made.

Throughout this application, various publications are referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An exfoliated, high I.V. polymer-platelet particle nanocomposite comprising:
a high molecular weight matrix polyamide having diamine and diacid repeat units, and
platelet particles exfoliated in the matrix polyamide,
wherein the platelet particles are dispersed in an oligomeric polyamide resin and
wherein the platelet particle-oligomer resin dispersion is incorporated into the matrix polyamide.

2. The nanocomposite of claim 1, wherein the high molecular weight matrix polyamide is poly(m-xylylene adipamide) or a copolymer thereof, isophthalic acid-modified poly(m-xylylene adipamide) or a copolymer thereof, or a mixture thereof.

3. The nanocomposite of claim 1, wherein the oligomeric resin and the high molecular weight matrix polymer have the same monomer units.

4. The nanocomposite of claim 1, wherein the oligomeric resin is oligo(m-xylylene adipamide), or a cooligomer thereof, and the high molecular weight matrix polymer is poly(m-xylylene adipamide), or a copolymer thereof.

5. The nanocomposite of claim 1, wherein the nanocomposite material comprises greater than zero to about 25 weight percent of platelet particles.

6. The nanocomposite of claim 1, wherein the platelet particles have a thickness of less than about 20 nm and a diameter of about 10 to about 5000 nm.

7. The nanocomposite of claim 1, wherein the platelet particles are derived from organic or inorganic clay material.

8. The nanocomposite of claim 7, wherein the clay material is a natural, synthetic or modified phyllosilicate.

9. The nanocomposite of claim 1, having an I. V. of at least 0.9 dL/g as measured in a mixture of 60 weight percent phenol and 40 weight percent 1,1,2,2-tetrachloroethane at a concentration of 0.5 g/100 ml (solvent) at 25° C.

10. The nanocomposite of claim 1, wherein at least 75 percent of the platelet particles are dispersed in the form of individual platelets and aggregates in the nanocomposite material.

11. The nanocomposite of claim 10, having an I.V. of at least 0.9 dL/g as measured in a mixture of 60 weight percent phenol and 40 weight percent 1,1,2,2-tetrachloroethane at a concentration of 0.5 g/100 ml (solvent) at 25° C.

12. A process for preparing an exfoliated, high I.V. polymer-platelet particle nanocomposite comprising the steps of:
(i) melt mixing platelet particles with an oligomeric polyamide resin to form an oligomeric resin-platelet particle composite, and
(ii) mixing the oligomeric resin-platelet particle composite with a high molecular weight matrix polyamide having diamine and diacid repeat units, thereby increasing the molecular weight of the oligomeric resin-platelet particle composite and producing an exfoliated, high I.V. polymer nanocomposite material.

13. The process of claim 12, wherein step (i) is conducted by a batch mixing or a melt compounding extrusion process.

14. The process of claim 12, wherein step (i) is conducted by (a) dry mixing the oligomeric resin with platelet particles prior to melt mixing, thereby forming a dry mixture, and (b) melt mixing the dry mixture through a compounding extruder to form the oligomeric resin-platelet particle composite.

15. The process of claim 12, wherein step (i) is conducted by
(a) feeding the oligomeric resin and platelet particles separately into a compounding extruder, and
(b) melt mixing the oligomeric resin and platelet particles through the compounding extruder to form the oligomeric resin-platelet particle composite.

16. The process of claim 12, wherein step (i) is conducted by
(a) feeding the oligomeric resin into a compounding extruder,
(b) feeding platelet particles into the compounding extruder after the oligomeric resin, and
(c) melt mixing the oligomeric resin and platelet particles through the compounding extruder to form the oligomeric resin-platelet particle composite.

17. The process of claim 12, wherein step (i) is conducted by melt mixing the oligomeric resin with the platelet particles in a reactor to form the oligomeric resin-platelet particle composite prior to feeding the melt mixture into a compounding extruder.

18. The process of claim 12, wherein step (i) is conducted by
(a) melting the oligomeric resin to form molten oligomeric resin, and
(b) melt mixing the molten oligomeric resin and platelet particles through a compounding extruder to form the oligomeric resin-platelet particle composite.

19. The process of claim 12, wherein step (ii) is conducted by melt compounding the oligomeric resin-platelet particle composite with the high molecular weight matrix polyamide.

20. The process of claim 12, wherein the high molecular weight matrix polyamide has a weight average molecular weight greater than 20,000 g/mol.

21. The process of claim 12, wherein the high molecular weight matrix polyamide has an I. V. of at least 0.7 dL/g as measured in a mixture of 60 weight percent phenol and 40 weight percent 1,1,2,2-tetrachloroethane at a concentration of 0.5 g/100 ml (solvent) at 25° C.

22. The process of claim 12, wherein the polyamide is poly(m-xylylene adipamide) or a copolymer thereof, isophthalic acid-modified poly(m-xylylene adipamide) or a copolymer thereof, or a mixture thereof.

23. The process of claim 12, wherein the oligomeric resin and the high molecular weight matrix polymer have the same monomer units.

24. The process of claim 12, wherein the oligomeric resin is oligo(m-xylylene adipamide), or a cooligomer thereof, and the high molecular weight matrix polymer is poly(m-xylylene adipamide), or a copolymer thereof.

25. The process of claim 12, wherein the oligomeric resin is an oligomeric polyester.

26. The process of claim 12, wherein the oligomeric resin is an oligomeric polyamide.

27. The process of claim 12, wherein the oligomeric resin is a homooligomer or cooligomer.

28. The process of claim 12, wherein the oligomeric resin has an I.V. of from about 0.1 dL/g to about 0.5 dL/g as measured in a mixture of 60 weight percent phenol and 40 weight percent 1,1,2,2-tetrachloroethane at a concentration of 0.5 g/100 ml (solvent) at 25° C.

29. The process of claim 12, wherein the oligomeric resin has a number average molecular weight of from about 200 to about 10,000 g/mol.

30. The process of claim 12, wherein the nanocomposite material comprises greater than zero to about 25 weight percent of platelet particles.

31. The process of claim 12, wherein the nanocomposite material comprises from about 0.1 to about 15 weight percent of platelet particles.

32. The process of claim 12, wherein the nanocomposite material comprises from about 0.5 to about 10 weight percent of platelet particles.

33. The process of claim 12, wherein at least about 75 percent of the platelet particles are dispersed in the form of individual platelets and aggregates in the nanocomposite material.

34. The process of claim 12, wherein the platelet particles have a thickness of less than about 20 nm and a diameter of from about 10 to about 5000 nm.

35. The process of claim 12, wherein the platelet particles are derived from organic or inorganic layered clay material.

36. The process of claim 12, wherein the clay material is in the form of pellets, flakes, chips, powder, or a mixture thereof.

37. The process of claim 12, wherein the clay material is a natural, synthetic or modified phyllosilicate.

38. The process of claim 12, wherein the phyllosilicate is smectite, sodium montmorillonite, sodium hectorite, bentonite, nontronite, beidelite, volonsloite, saponite, sauconite, magadite, kenyaite, or synthetic sodium hectorite or a mixture thereof.

39. The process of claim 12, wherein the platelet particles are treated with a water soluble or insoluble polymer, an organic reagent or monomer, a silane compound, a metal, an organometallic, or an organic cation, to effect cation exchange, or a combination thereof.

40. The process of claim 12, wherein the organic cation is not an organic cation salt represented by Formula (I): 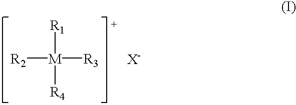
wherein M is nitrogen or phosphorous, X⁻ is a halide, hydroxide, or acetate anion, R₁ is a straight or branched alkyl group having at least 8 carbon atoms, and R₂, R₃, and R₄ are independently hydrogen or a straight or branched alkyl group having 1 to 4 carbon atoms.

41. The process of claim 12, wherein the platelet particles are derived from a clay material that is a free flowing powder having a cation exchange capacity from about 0.3 to about 3 meq/g.

42. The process of claim 12, wherein the cation exchange capacity is from about 0.8 to about 1.5 meq/g.

43. A nanocomposite material produced by the process of claim 12.

44. A process for preparing an exfoliated, high I.V. polymer-platelet particle nanocomposite comprising:
melt mixing platelet particles, an oligomeric polyamide resin, and a high molecular weight matrix polyamide having diamine and diacid repeat units,
thereby increasing the molecular weight of the mixture and producing an exfoliated, high I.V. polymer nanocomposite material.

45. The process of claim 44, wherein the high molecular weight matrix polyamide has a weight average molecular weight greater than 20,000 g/mol.

46. The process of claim 44, wherein the matrix polyamide is poly(m-xylylene adipamide) or a copolymer thereof, isophthalic acid-modified poly(m-xylylene adipamide) or a copolymer thereof, or a mixture thereof.

47. The process of claim 44, wherein the oligomeric resin and the high molecular weight matrix polyamide have the same monomer units.

48. The process of claim 44, wherein the oligomeric resin is oligo(m-xylylene adipamide), or a cooligomer thereof, and the high molecular weight matrix polyamide is poly(m-xylylene adipamide), or a copolymer thereof.

49. The process of claim 44, wherein the oligomeric resin is a homooligomer or cooligomer.

50. The process of claim 44, wherein the oligomeric resin has an I.V. of from about 0.1 dL/g to about 0.5 dL/g as measured in a mixture of 60 weight percent phenol and 40 weight percent 1,1,2,2-tetrachloroethane at a concentration of 0.5 g/100 ml (solvent) at 25° C.

51. The process of claim 44, wherein the nanocomposite material comprises greater than zero to about 25 weight percent of platelet particles.

52. The process of claim 44, wherein at least about 75 percent of the platelet particles are dispersed in the form of individual platelets and aggregates in the nanocomposite material.

53. The process of claim 44, wherein the platelet particles are derived from organic or inorganic layered clay material.

54. The process of claim 44, wherein the platelet particles are treated with a water soluble or insoluble polymer, an organic reagent or monomer, a silane compound, a metal, an organometallic, or an organic cation, to effect cation exchange, or a combination thereof.

55. The process of claim 54, wherein the organic cation is not an organic cation salt represented by Formula (I): 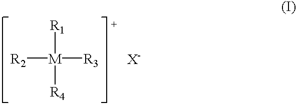
wherein M is nitrogen or phosphorous, X⁻ is a halide, hydroxide, or acetate anion, R₁ is a straight or branched alkyl group having at least 8 carbon atoms, and R₂, R₃, and R₄ are independently hydrogen or a straight or branched alkyl group having 1 to 4 carbon atoms.

56. A nanocomposite material produced by the process of claim 44.

57. A process for preparing an exfoliated, high I.V. polymer-platelet particle nanocomposite comprising the steps of:
(i) melt mixing platelet particles with an oligomeric polyamide resin having diamine and diacid repeat units to form an oligomeric polyamide resin-platelet particle composite, and
(ii) increasing the molecular weight of the oligomeric polyamide resin-platelet particle composite by reactive chain extension of the oligomeric polyamide resin to produce an exfoliated, high I.V. nanocomposite material.

58. The process of claim 57, wherein the oligomeric polyamide resin is an oligomeric polyamide.

59. The process of claim 57, wherein the oligomeric polyamide resin has an I. V. of from about 0.1 dL/g to about 0.5 dL/g as measured in a mixture of 60 weight percent phenol and 40 weight percent 1,1,2,2-tetrachloroethane at a concentration of 0.5 g/100 ml (solvent) at 25° C.

60. The process of claim 57, wherein the platelet particles are treated with a water soluble or insoluble polymer, an organic reagent or monomer, a silane compound, a metal, an organometallic, or an organic cation, to effect cation exchange, or a combination thereof.

61. The process of claim 60, wherein the organic cation is not an organic cation salt represented by Formula (I): 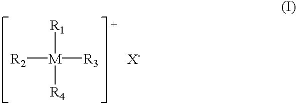
wherein M is nitrogen or phosphorous, X⁻ is a halide, hydroxide, or acetate anion, R₁ is a straight or branched alkyl group having at least 8 carbon atoms, and R₂, R₃, and R₄ are independently hydrogen or a straight or branched alkyl group having 1 to 4 carbon atoms.

62. A process for preparing an exfoliated, high I.V. polymer-platelet particle nanocomposite comprising the steps of:
(i) contacting a clay with an organic cation to form an organoclay comprising platelet particles,
(ii) melt mixing the organoclay with an oligomeric polyamide resin to form an oligomeric resin-platelet particle composite, and
(iii) mixing the oligomeric resin-platelet particle composite with a high molecular weight matrix polyamide having diamine and diacid repeat units, thereby increasing the molecular weight of the oligomeric resin-platelet particle composite and producing an exfoliated, high I.V. polymer nanocomposite material.

63. The process of claim 62, wherein step (ii) is conducted by a batch mixing or a melt compounding extrusion process.

64. The process of claim 62, wherein step (iii) is conducted by melt compounding the oligomeric resin-platelet particle composite with the high molecular weight matrix polyamide.

65. The process of claim 62, wherein the organic cation is not an organic cation salt represented by Formula (I): 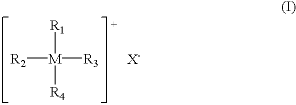
wherein M is nitrogen or phosphorous, X⁻ is a halide, hydroxide, or acetate anion, R₁ is a straight or branched alkyl group having at least 8 carbon atoms, and R₂, R₃, and R₄ are independently hydrogen or a straight or branched alkyl group having 1 to 4 carbon atoms.

66. The nanocomposite of claim 4 wherein the platelet particles are derived from a sodium montmorillonite or bentonite.

67. The nanocomposite of claim 4, wherein the platelet particles are derived from a Wyoming montmorillonite or a Wyoming bentonite.

68. The nanocomposite of claim 4, wherein the platelet particles comprise an organic cation having the formula: 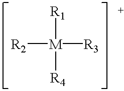
wherein M is nitrogen and R₁, R₂, R₃, and R₄ are organic ligands comprising linear or branched alkyl groups having 1 to 22 carbon atoms and alkylene oxide groups having 2 to 6 carbon atoms.

69. The nanocomposite of claim 4, wherein the platelet particles comprise the organic cation bis(2-hydroxyethyl)octadecyl methyl ammonium.

70. The nanocomposite of claim 67 wherein the platelet particles comprise the organic cation bis(2-hydroxyethyl)octadecyl methyl ammonium.

71. The nanocomposite of claim 70 wherein at least 75 percent of the platelet particles are dispersed in the form of individual platelets and aggregates in the nanocomposite material.
